(19) United States
(12) Patent Application Publication
(10) Pub. No.: US 2025/0250804 A1
(43) Pub. Date: Aug. 7, 2025

(54) Construction Disposition Introduced in Multifunctional Ladder

(71) Applicant: Edson Marcos Neppel, Irineopolis (BR)

(72) Inventor: Edson Marcos Neppel, Irineopolis (BR)

(21) Appl. No.: 19/047,775

(22) Filed: Feb. 7, 2025

(30) Foreign Application Priority Data
Feb. 7, 2024 (BR) 202024002547-0

(51) Int. Cl. E04G 1/24; E06C 1/39; E06C 1/397

(52) U.S. Cl. CPC E04G 1/24; E06C 1/39; E06C 1/397; E04G 2001/242

(57) ABSTRACT

The present disclosure is for a ladder, which will be used in various sectors, such as civil and electrical areas, maintenance of gutters, lamps, lifelines, installation of panels, painting, placement of plasterboards, lining, washing of facades, washing of cabins and upper parts of trucks, buses and trailers, and also in the logistics sector, providing configurations that can be used to improve ergonomic conditions and work to be performed in grain unloading hoppers, in the activity of tarpaulin and untarpaulin of the truck body, as well as facilitating access to the body with fastening through chains or ratchet straps engaged in the body structure, consisting basically of a multifunctional ladder (E) on wheels (2), with locking and manual and/or automatic guide cable, for adjustment of the necessary height, designed to reach from 2 to 10 meters in height.

### CROSS REFERENCE TO RELATED APPLICATION

This application takes priority from and claims the benefit of Brazilian Patent Application Serial No. BR 20 2024 002547 0 filed on Feb. 7, 2024, the contents of which are herein incorporated by reference.

### BACKGROUND OF THE INVENTION

### Field of the Invention

This descriptive report refers to a multifunctional ladder, which will be used in the area of occupational safety equipment, more specifically in the safe and economical access to the interior of truck bodies, in an extremely practical and efficient way, meeting the conditions to become worthy of the protection now requested.

### Description of the Related Art

Construction disposition introduced in multifunctional ladder, through improvements and technology employed, aims to create an innovative product, manufactured in metal material, which will be used in various sectors, such as civil and electrical areas, maintenance of gutters, lamps, lifelines, installation of panels, painting, placement of plasterboards, lining, washing of facades, washing of cabins and upper parts of trucks, buses and trailers, and also in the logistics sector, providing configurations that can be used to improve ergonomic conditions and work to be performed in hoppers with grain unloading, in the activity of tarpaulin and untarpaulin of the truck body, as well as facilitating access to the body with fastening through chains or ratchet straps engaged in the body structure, basically consisting of a multifunctional ladder (E) on wheels (2), with locking and manual and/or automatic guide cable, for adjustment of the necessary height, designed to reach from 2 to 10 meters high, bringing numerous advantages, such as providing safe and ergonomic access to higher variable heights, ease of transport, amongst others, dealing with an evolutionary solution, whose practical result obtained reports to a differentiated and effective condition of use.

### SUMMARY OF THE INVENTION

With the sole and exclusive purpose of providing veracity to the preamble of this description, the applicant will provide in the following paragraphs a brief, but consistent, explanation of the state of the art for the problems and drawbacks existing in multifunctional ladders, where it will be possible for a technician in the field to recognize their deficient aspects, in order to later clearly identify in the invention now claimed the requirement of novelty.

Working at heights is a reality in several areas of activity, which ends up making the activity frequent in work environments and at the same time a dangerous type of work. This frequent exposure of workers can often lead to work accidents.

Contrary to what we might think about the risk to the worker, working at height is not only that which involves high altitudes, such as building construction or mega-works related to large events such as stadiums.

Specifically, in NR 35—Regulatory Standard 35—it is defined that any activity carried out above 2 meters from the lower level already fits into the category of work at height. Therefore, all work carried out above 2 meters in height must follow the guidelines of NR 35, from safety procedures to the use of appropriate individual protection equipment or collective protection.

One of the main aspects that we must consider when working at height is work complacency, which is when you are already used to your work environment, feel comfortable with the situation and reduce your attention to the dangers or risk factors that exist in the work environment.

In the logistics sector, for example, where the use of ladders helps drivers and assistants access the inside of the truck body for loading and unloading procedures, the current state of the art reveals the use of ladders without locking on the body and without the possibility of extension attachment for internal access to truck bodies. Often the professional uses the body structure itself to get out of the internal part of it.

In view of the above in the technical foundations, with the passing of time and the accumulation of experience, the facts pointed in the direction of the construction of unprecedented improvements in multifunctional ladders, presenting several advantages, being quite practical and efficient, where its unique constructiveness eliminates the negative aspects known in the State of the Art, which is presented in this patent.

In order to overcome the problems presented, the inventor aims to, fundamentally, develop an innovative multifunctional high mobility ladder with locking and guide cable with manual and/or automatic activation, standing out in the consumer market due to the fact that it presents a differentiated product in relation to its construction and use, also obtaining a low cost, highly resistant and efficient product.

With many years of experience, and always seeking innovations and practical solutions to differentiate his products from those of competitors, the inventor developed this simple and efficient product, capable of overcoming all the limitations and inconveniences reported in the State of the Art in an extremely safe way.

According to this document, the invention consists of a multifunctional ladder on wheels, with locking and manual and/or automatic guide cable, for adjustment of the necessary height, designed to reach from 2 to 10 meters in height.

The ladder has a safe work platform at the top of the ladder, to facilitate access to high areas, and has safety devices such as built-in handrails, to meet the requirements of NR 12.

One of the product's great advantages is providing safe and ergonomic access to higher heights in various areas, such as civil and electrical areas, maintenance of gutters, lamps, lifelines, installation of panels, painting, placement of plasterboards, lining, washing of facades, washing of cabins and upper parts and trucks, buses and trailers, amongst others.

In the logistics sector, the constructive arrangement of the ladder provides configurations that can be used to improve ergonomic conditions and work to be carried out in the hoppers with grain unloading, in the activity of tarpaulining and untarpaulining the truck body, as well as facilitating access to the body with fixing through chains or ratchet straps engaged in the body structure.

In addition to being easy to transport, the ladder is designed to accommodate varying heights, providing versatility of use.

It is important to understand that the instant application is illustrated in a demonstrative and non-limiting manner as to the application of the details, dimensions, capacities and steps described. It is capable of other modalities and of being practiced or executed in a variety of ways, without logically straying from the main inventive scope of the object, whose protection is claimed.

### BRIEF DESCRIPTION OF THE DRAWINGS

To complement this description in order to obtain a better understanding of the characteristics of this application and in accordance with a preferred practical implementation thereof, the description is accompanied, in annex, by a set of drawings, where, by way of example, the following is represented:

FIG. 1—Perspective view of the ladder;

FIG. 2—Perspective view of the ladder being activated;

FIG. 3—Perspective view of the ladder being activated;

FIG. 4—Detailed view of the ladder; In this view, we can see the locking between steps;

FIG. 5—Detailed view of the ladder;

FIG. 6—Detailed view of the ladder; In this view, we can see that when the lever is pressed, the mobile ladder slides upwards, also sliding the mobile arm with return spring behind the step of the fixed ladder;

FIG. 7—Detailed view of the ladder; In this view, the movable arm with return spring and small front support are almost passing through the step;

FIG. 8—Detailed view of the ladder; In this view, the mobile arm with return spring and small front support has already passed completely through the step of the fixed ladder;

FIG. 9—Detailed view of the ladder; In this view, the mobile arm with return spring and small front support has already passed completely through the step of the fixed ladder;

FIG. 10—Detailed view of the locking of the lever locking;

FIG. 11—Detailed view of the lever locking. In this view we can see the rod with the cutout already fitted into the lever;

FIG. 12—Detailed view of the tire locking.

FIG. 13—Perspective view of the ladder. In this view, we can see the side rods and open rear rods, to reinforce and support the platform;

FIG. 14—Perspective view of the ladder. In this view, we can see the platform with its door open;

FIG. 15—Perspective view of the ladder;

FIG. 16—Perspective view of the leaver;

FIG. 17—Perspective view of the lower base with four tires;

FIG. 18—Side view as per previous image;

FIG. 19—Perspective view of the fixed ladder;

FIG. 20—Perspective view of the mobile ladder;

FIG. 21—Perspective view of the fixed ladder with lever;

FIG. 22—Side view as per previous figure;

FIG. 23—Frontal view as per previous figure;

FIG. 24—Perspective view of the platform;

FIG. 25—Frontal view of the articulated side rods;

FIG. 26—Perspective view of the locking system;

FIG. 27—Side view as per previous figure.

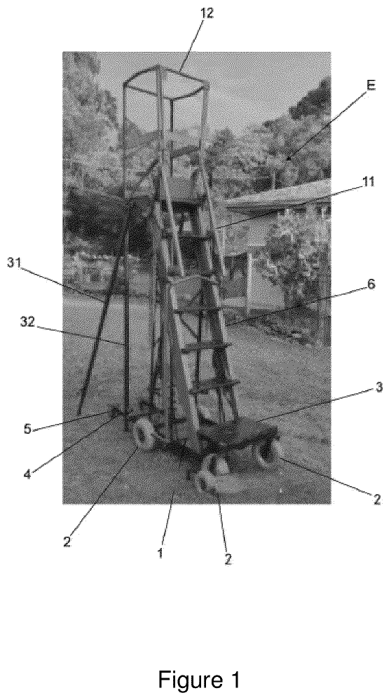

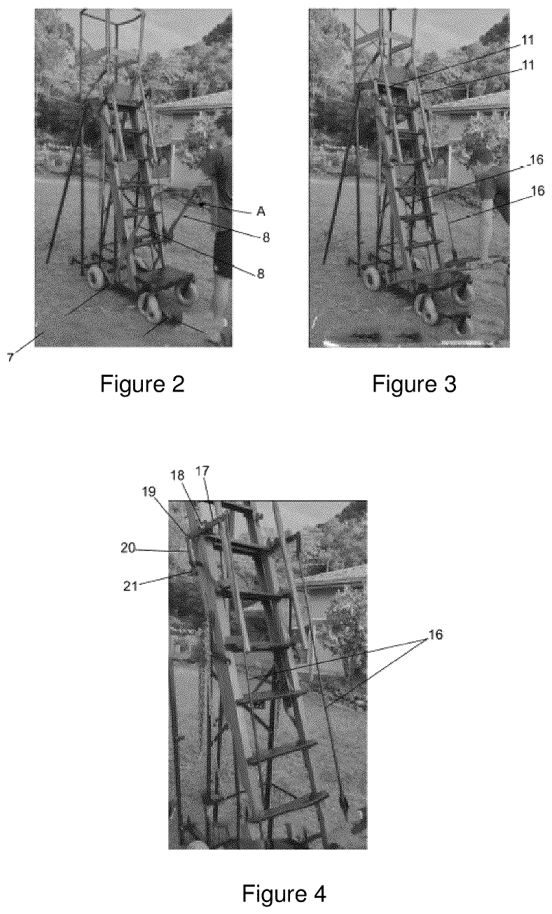

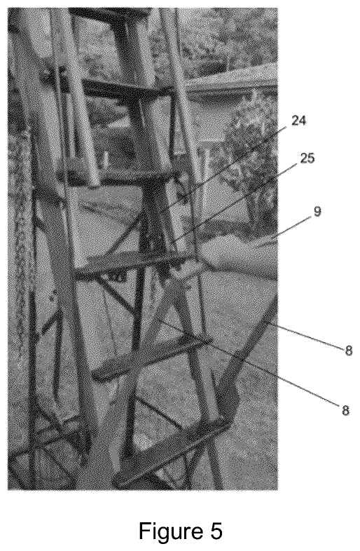

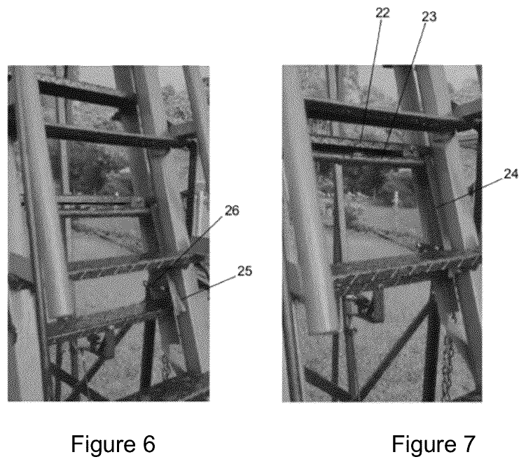

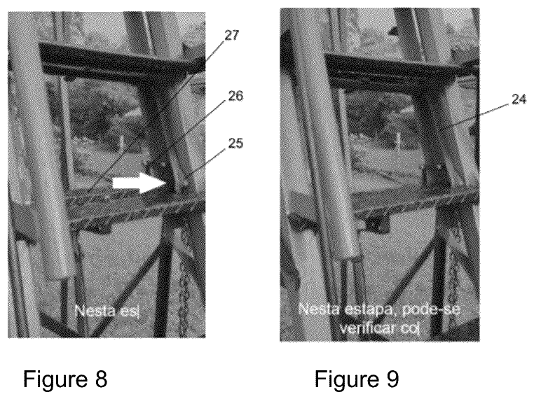

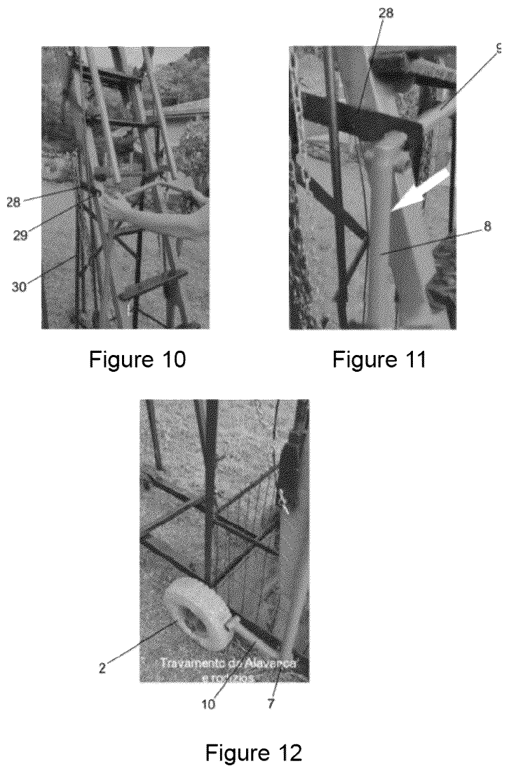

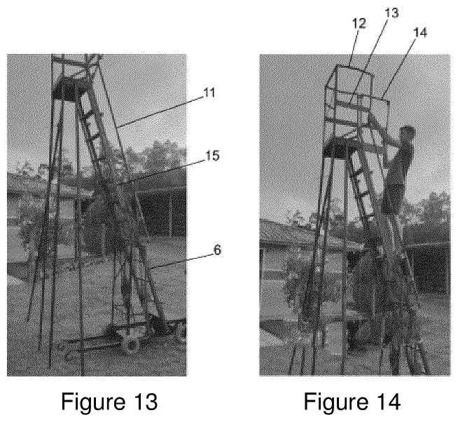

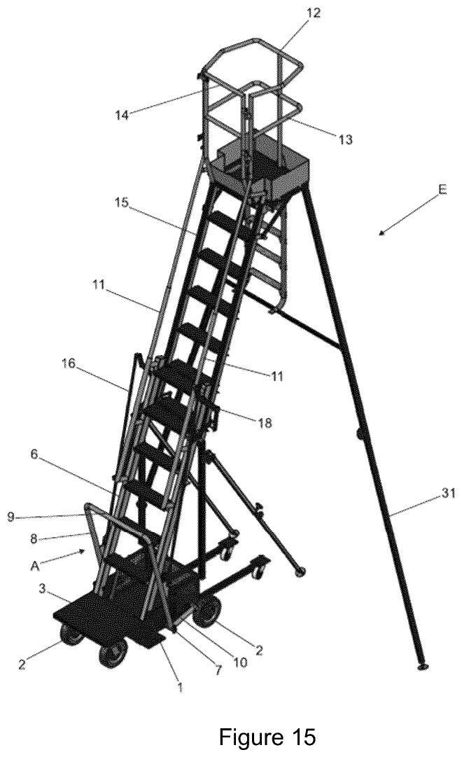

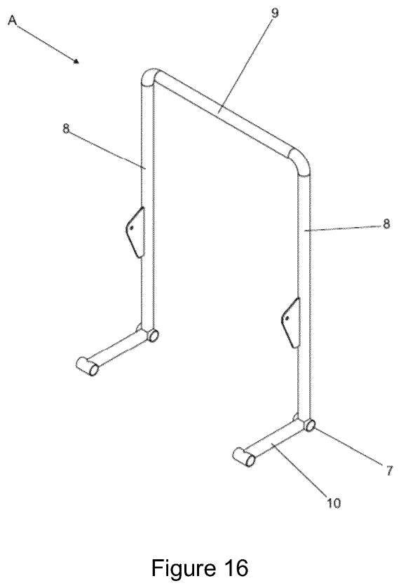

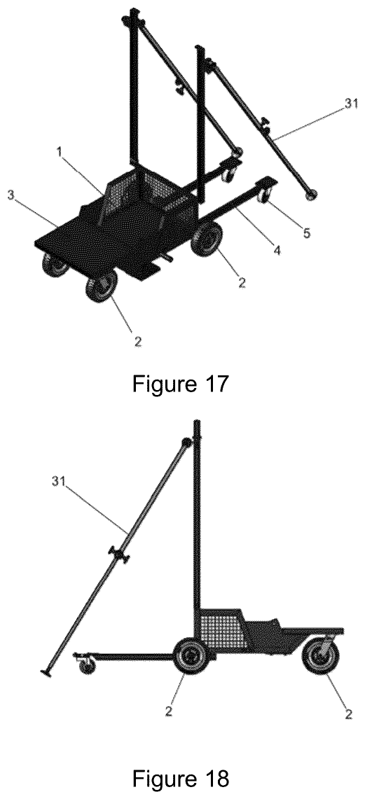

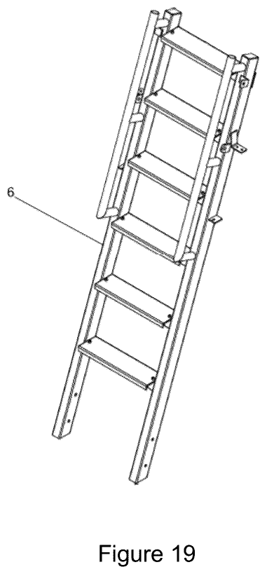

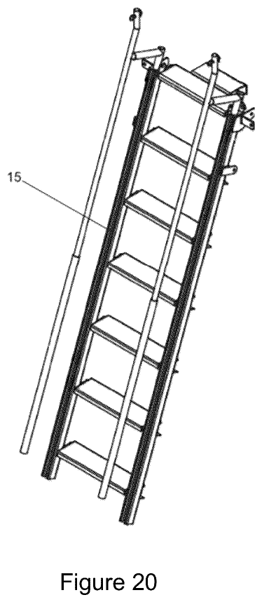

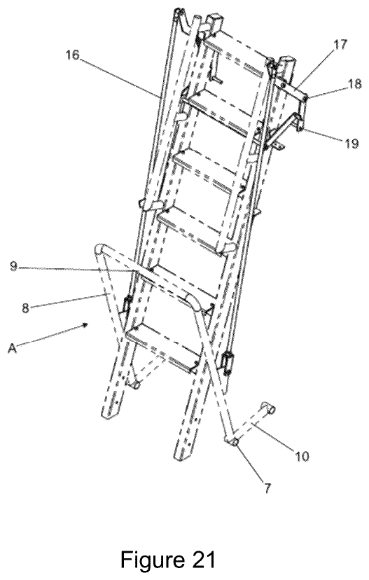

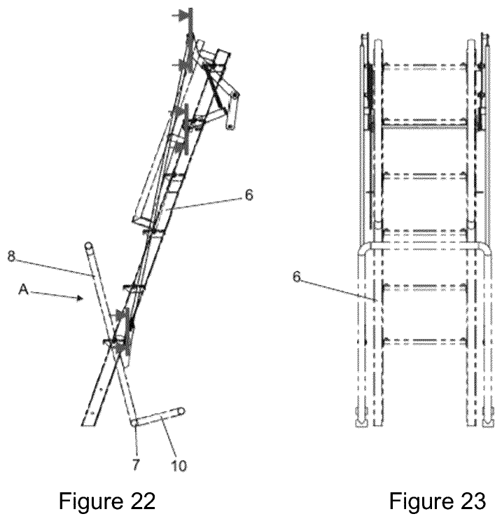

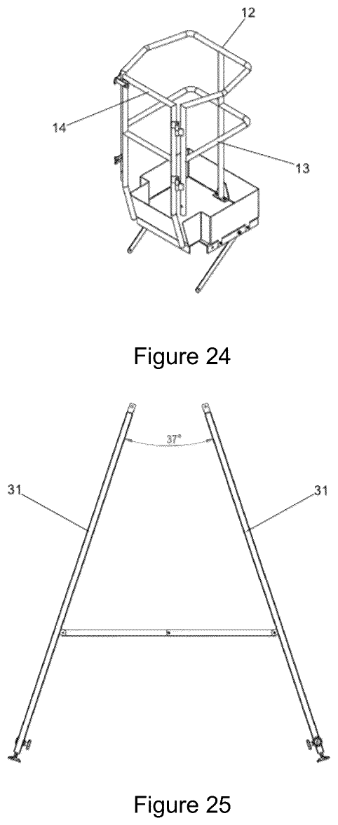

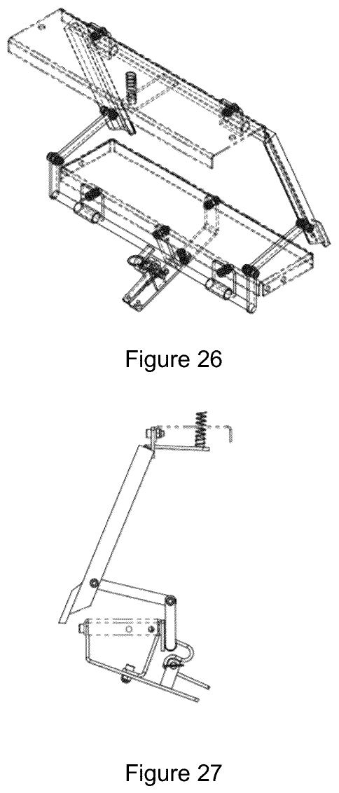

### DETAILED DESCRIPTION OF THE SEVERAL EMBODIMENTS

In accordance with the attached drawings, the CONSTRUCTION DISPOSITION INTRODUCED IN MULTIFUNCTIONAL LADDER, which is the subject of this application, comprises a ladder (E) consisting of a lower base (1) equipped with four tires (2) and which has a small extra step (3) in the front region. At its rear end there are two rods (4) with casters (5).

In the front region of the said lower base (1), close to the said small extra step (3), a fixed ladder (6) is provided, and on its sides, the lower base (1) has an axis (7) where the end of a manual operating lever (A) is fixed, consisting of two arms (8) joined at their end by a transverse rod (9). The operating lever (A) is also equipped, at its lower end next to said axis (7), with a small perpendicular rod (10).

In the central region of the fixed staircase (6) there are two telescopic handrails (11) connected at their upper end to an upper platform (12), with side closures (13) and an access door (14), which in turn is fixed to a mobile ladder (15), arranged in parallel, in the rear region of said fixed ladder (6).

In the central region of each arm (8) of the manual operating lever (A), rods (16) are fixed, connected at the top to the front end of an articulation arm (17), which is fixed centrally to an axle (18), located at the upper end of the fixed ladder (6). The opposite end of the articulation arm (17) has an axis (19) to which a small free arm (20) is fixed, projecting downwards, equipped with a lower support (21).

The mobile ladder (15) also has a locking system between steps, which consists of a bar with an axle (22) fixed to the penultimate step (23) of the mobile ladder (15), which projects, at the bottom, a mobile arm with a return spring (24) equipped with a small front support (25), and which also has a small rear joint (26) fixed to the last step (27) also of the mobile ladder (15).

The ladder (E) also has a lever locking system (A), consisting of two small mobile rods (28) with cutouts (29), provided in a vertical of the fixed ladder (6).

The upper platform (12) is equipped with individual articulated side rods (31), with height adjustment, and also a set of rear rods (32), locked by a transverse crossbar (33), to reinforce and support the platform (12).

Thus constructed, the ladder (E) is operated manually using the operating lever (A) from the vertical downward position. This operation causes the rods (16) connected to the articulation arm (17) to move the small free arm (20), fitting its lower support (21) into the lower region of the steps of the mobile ladder (15), causing the mobile ladder to move upwards, and also moving the upper platform by jointly actuating the telescopic handrails (11). Simultaneously with this upward movement, the steps are locked by means of the mobile arm with return spring (24), which articulates backwards and slides in the rear region of the steps of the fixed ladder (6), resting its small front support (25) on the surface of the steps of the fixed ladder (6), whenever it passes over them.

When the height of the ladder is reached, the operating lever (A) returns to the vertical position and is locked by the two small mobile rods (28) with cutouts (29), also locking the front tires (2) by contact with the perpendicular rod (10), provided at the lower end of the lever.

For safety, the upper platform (12) is also supported and locked by the individual articulated side rods (31), with height adjustment, and also by the set of rear rods (32), with crossbar (33).

Although one form of the invention has been shown and described, other forms will be apparent to those skilled in the art. Therefore, it will be understood that the embodiments shown in the drawings and described above are for illustrative purposes only and are not intended to limit the scope of the instant application which is defined by the claims which follow.

What is claimed is:

1. CONSTRUCTION DISPOSITION INTRODUCED IN MULTIFUNCTIONAL LADDER, characterized by a ladder (E) consisting of a lower base (1) equipped with four tires (2) and which has a small extra step (3) in the front region; at its rear end there are two rods (4) with casters (5); in the front region of said lower base (1), close to said small extra step (3), a fixed ladder (6) is provided, and on its sides, the lower base (1) has an axis (7) where the end of a manual operating lever (A) is fixed, consisting of two arms (8) joined at its end by a transverse rod (9); the operating lever (A) is also equipped, at its lower end next to said axis (7), with a small perpendicular rod (10); in the central region of the fixed ladder (6) there are two telescopic handrails (11) connected at their upper end to an upper platform (12), with side closures (13) and access door (14), which in turn is fixed to a mobile ladder (15), arranged in parallel, in the rear region of said fixed ladder (6); in the central region of each arm (8) of the manual operating lever (A) there are fixed rods (16) connected at the top to the front end of an articulation arm (17), this one fixed centrally to an axle (18), located at the upper end of the fixed ladder (6); the opposite end of the articulation arm (17) has an axle (19) where a small free arm (20) is fixed, projecting downwards, equipped with a lower support (21); the mobile ladder (15) also has a locking system between steps, which consists of a bar with an axle (22) fixed to the penultimate step (23) of the mobile ladder (15), which projects, at the bottom, a mobile arm with a return spring (24) equipped with a small front support (25), and which also has a small rear joint (26) fixed to the last step (27), also of the mobile ladder (15); the ladder (E) also has a locking system for the lever (A), consisting of two small mobile rods (28) with cutouts (29), provided in a vertical structure (30), projected from the lower base (1) to the central region of the fixed ladder (6); the upper platform (12) is equipped with individual articulated side rods (31), with height adjustment, and also a set of rear rods (32), locked by a transverse crossbar (33), to reinforce and support the platform (12).
